(19) United States
(12) Patent Application Publication
(10) Pub. No.: US 2011/0061418 A1
(43) Pub. Date: Mar. 17, 2011

(54) HEAT PUMP TYPE HOT-WATER HEATER

(75) Inventors: Hiroshi Ishihara, Nara (JP); Toshihiro Horiuchi, Nara (JP); Toshikatsu Fukunaga, Osaka (JP); Yoshitaka Suita, Shiga (JP)

(73) Assignee: Panasonic Corporation, Osaka (JP)

(21) Appl. No.: 12/704,934

(22) Filed: Feb. 12, 2010

(30) Foreign Application Priority Data
Sep. 17, 2009 (JP) 2009-215357

(51) Int. Cl. F25B 13/00; F24D 17/02; G05D 23/00

(52) U.S. Cl. 62/324.3; 165/53; 165/288

(57) ABSTRACT

A heat pump type hot-water heater includes a hot-water tank, a heat pump cycle for heating hot water, a partition plate which divides an interior of the hot-water tank into an upper space and a lower space, a hot-water supply heat exchanger which exchanges heat of water with heat of hot water in the hot-water tank to produce high temperature hot water, a hot water supply pump which sends hot water in the hot-water tank to the hot-water supply heat exchanger, a heating terminal which heats a room, and a heating pump which sends hot water in the hot-water tank to the heating terminal.

### TECHNICAL FIELD

The present invention relates to a heat pump type hot-water heater which heats air using hot water produced by a heat pump.

### BACKGROUND TECHNIQUE

Conventionally, most of heaters use combustible fuel such as petroleum and gas as a heat source, but in recent years, market share of heaters utilizing a heat pump technique is sharply increasing. There are also conventional air conditioners which can be used for cooling and heating air utilizing the heat pump technique.

However, the conventional air conditioners have a problem that a foot area is not easily heated at the time of heating operation, and hot-water heaters utilizing the heat pump technique are developed to solve the problem (see patent document 1 for example). According to a hot-water heater described in patent document 1, heat is exchanged between a high temperature refrigerant and hot water, hot water whose temperature is increased by the heat exchange is sent to a heating terminal such as a floor heating panel, thereby heating air.

FIG. 11 is a block diagram showing a conventional heat pump type hot-water heater. As shown in FIG. 11, according to the conventional heat pump type hot-water heater, a compressor 101, a refrigerant channel of a water refrigerant heat exchanger 102, a decompressor 103 and an evaporator 104 are annularly connected to one another through a refrigerant piping 105, thereby constituting a refrigeration cycle 106, and a water channel of the water refrigerant heat exchanger 102, a boiling pump 109 and a hot-water tank 110 are annularly connected to one another, thereby constituting a boiling cycle.

If a heating operation is started, a hot water circulation pump 111 is driven, and hot water in the hot-water tank 110 is sent to a heating terminal 108. When a hot water supply operation is to be carried out, heat exchange is carried out between hot water and high temperature water in the hot-water tank 110 by a hot-water supply heat exchanger 112, and hot water is supplied to a hot-water supply terminal.

### PRIOR ART DOCUMENT

### Patent Document

[Patent Document 1] Japanese Patent Application Laid-open No. 2008-39305

### SUMMARY OF THE INVENTION

### Problem to be Solved by the Invention

According to the heat pump type hot-water heater having the above-described conventional structure, the hot-water supply heat exchanger 112 is provided from a lower portion to an upper portion in the hot-water tank 110, and hot water to be supplied is produced by the hot-water supply heat exchanger 112 using hot water that is to be sent to the heating terminal 108. Therefore, the temperature of the entire hot water in the hot-water tank 110 falls and as a result, the temperature of hot water that is to be sent to a heating terminal falls and thus, there is a problem that a degree of comfort in the heating terminal is deteriorated.

The present invention has been accomplished to solve the conventional problem, and it is an object of the invention to provide a heat pump type hot-water heater capable of suppressing a temperature reduction of hot water to be sent to a heating terminal without deteriorating a degree of comfort even if hot water in a hot-water tank is used for heat exchange of hot water that is to be supplied.

### Means for Solving the Problem

To solve the conventional problem, the present invention provides a heat pump type hot-water heater comprising a hot-water tank in which hot water is stored, a heat pump cycle for heating hot water in the hot-water tank, a partition plate for dividing an interior of the hot-water tank into an upper space and a lower space, a hot-water supply heat exchanger which exchanges heat between water supplied from a water supply source and hot water in the hot-water tank to heat the water to a high temperature, a hot water supply pump which sends hot water in the hot-water tank to the hot-water supply heat exchanger, a heating terminal which circulates hot water in the hot-water tank and heats a room, and a heating pump which sends hot water in the hot-water tank to the heating terminal, wherein hot water in the upper space is sent to the hot-water supply heat exchanger, hot water after its heat is exchanged by the hot-water supply heat exchanger is returned from a bottom of the hot-water tank, hot water in the lower space is sent to the heating terminal, and hot water after its heat is exchanged by the heating terminal is returned from the bottom of the hot-water tank.

An interior of the hot-water tank is divided into the upper space and the lower space by a partition plate, a hot water section which sends hot water to the hot-water supply heat exchanger and a hot water section which sends hot water to the heating terminal are divided from each other so that thermal influences received by both the hot water sections can be minimized. Hot water after its heat is radiated by the hot-water supply heat exchanger is made to enter from a bottom of the hot-water tank. With this, even if heat exchange is carried out by the hot-water supply heat exchanger, high temperature hot water can be sent to the heating terminal without destroying a temperature layer in the lower space, and the degree of comfort in the heating terminal is not deteriorated.

### EFFECT OF THE INVENTION

The present invention can provide a heat pump type hot-water heater which suppress a decrease in temperature of hot water to be sent to the heating terminal even if hot water that is to be supplied is produced, and which does not deteriorate a degree of comfort.

### BRIEF DESCRIPTION OF THE DRAWINGS

FIG. 1 is a block diagram of a heat pump type hot-water heater according to a first embodiment of the present invention;

FIG. 2 is a partial sectional view of a hot-water tank in the first embodiment;

FIG. 3 is a sectional view taken along the A-A line in the first embodiment;

FIG. 4 is a sectional view taken along the B-B line in the first embodiment;

FIG. 5(a) is a front view showing a structure of a heat exchange unit B in the first embodiment and FIG. 5(b) is a perspective view showing a partial structure of the heat exchange unit B in the first embodiment;

FIG. 6 is a front view of a remote controller of a tank unit in the first embodiment;

FIG. 7 is a driving timing diagram of a flow-rate adjusting valve of the first embodiment;

FIG. 8 is a characteristic diagram of the flow-rate adjusting valve of the first embodiment;

FIG. 9 is an opening transition diagram of the flow-rate adjusting valve of the first embodiment;

FIG. 10 is an opening transition diagram of the flow-rate adjusting valve of the first embodiment;

FIG. 11 is a block diagram of a conventional heat pump type hot-water heater.

### EXPLANATION OF SYMBOLS

1 compressor
2 water refrigerant heat exchanger
3 decompressor
4a evaporator
4b air-blowing fan
5 four-way valve
6 refrigerant pipe
7 hot-water tank
8 partition plate
9 boiling pump
10 water outlet
11 hot water inlet
12a, 12b temperature sensor
13 flow switch
14 overpressure relief valve
15a upper heater
15b lower heater
16a to 16d temperature sensor
17 hot-water supply terminal
18 hot-water supply heat exchanger
19 hot water supply pump
20 hot water outlet
21 water inlet
22 flow-rate adjusting valve
23 check valve
24 overpressure relief valve
25 drain plug
26 feed water pipe
27 three-way valve
28 overpressure relief valve
29 overpressure relief valve
30 hot water supply pipe
31 temperature sensor
32 auxiliary temperature sensor
33 flow rate sensor
34 heating terminal
35 heating pump
36 hot water take-out port
37 remote controller
38 remote controller
39a to 39c controller
A heat pump unit
B heat exchange unit
C tank unit

### Exemplary Examples of the Invention

A first aspect of the present invention provides a heat pump type hot-water heater comprising a hot-water tank in which hot water is stored, a heat pump cycle for heating hot water in the hot-water tank, a partition plate for dividing an interior of the hot-water tank into an upper space and a lower space, a hot-water supply heat exchanger which exchanges heat between water supplied from a water supply source and hot water in the hot-water tank to heat the water to a high temperature, a hot water supply pump which sends hot water in the hot-water tank to the hot-water supply heat exchanger, a heating terminal which circulates hot water in the hot-water tank and heats a room, and a heating pump which sends hot water in the hot-water tank to the heating terminal, wherein hot water in the upper space is sent to the hot-water supply heat exchanger, hot water after its heat is exchanged by the hot-water supply heat exchanger is returned from a bottom of the hot-water tank, hot water in the lower space is sent to the heating terminal, and hot water after its heat is exchanged by the heating terminal is returned from the bottom of the hot-water tank. According to the invention, an interior of the hot-water tank is divided into the upper space and the lower space by a partition plate, a hot water section which sends hot water to the hot-water supply heat exchanger and a hot water section which sends hot water to the heating terminal are divided from each other so that thermal influences received by both the hot water sections can be minimized. Hot water after its heat is radiated by the hot-water supply heat exchanger is made to enter from a bottom of the hot-water tank. With this, even if heat exchange is carried out by the hot-water supply heat exchanger, high temperature hot water can be sent to the heating terminal without destroying a temperature layer in the lower space, and the degree of comfort in, the heating terminal is not deteriorated.

According to a second aspect of the invention, the heat pump type hot-water heater of the first aspect further comprises an upper heater located in the upper space and a lower heater located in the lower space, and hot water heated by the heat pump cycle is returned to the lower space, and hot water in the upper space is heated to a temperature higher than that of the hot water in the lower space. According to the invention, hot water of a temperature that is higher than a temperature of hot water to be sent to the heating terminal can be supplied to the hot-water supply heat exchanger. Therefore, a temperature of hot water to be sent to the hot-water supply terminal can be increased in a short time.

According to a third aspect of the invention, the heat pump type hot-water heater of the second aspect further comprises a first temperature sensor in a location at substantially the same height as the upper heater, and a second temperature sensor in a location higher than the first temperature sensor, a heating operation of the upper heater is started based on the second temperature sensor, and the heating operation of the upper heater is stopped based on the first temperature sensor. According to the invention, even if hot water having a low temperature in the lower space flows into the upper space, since the operation of the upper heater is started when it is detected by the upper second temperature sensor that the temperature is lower by a predetermined temperature, the operation of the upper heater is not frequently started, and durability of the upper heater can be enhanced.

According to a fourth aspect of the invention, in the heat pump type hot-water heater of any one of first to third aspects, the partition plate includes a plurality of openings. According to the invention, hot water in the upper space is sent to the hot-water supply heat exchanger, and after heat exchange is carried out by the hot-water supply heat exchanger, hw in the lower space moves to the upper space through the plurality of openings even if the hot water is returned from the bottom of the hot-water tank. Therefore, hot water in the lower space is not stirred and it is possible to prevent a temperature layer from being destroyed. If the partition plate is not provided with the openings, when hot water after its heat is exchanged flows from the bottom of the hot-water tank, hot water in the lower space is pushed up by the upper space, the hot water is stirred by the partition plate, the temperature layer is destroyed, the temperature of hot water to be sent to the heating temperature is lowered, and the degree of comfort is deteriorated.

According to a fifth aspect of the invention, in the heat pump type hot-water heater of any one of the first to fourth aspects, a periphery of the partition plate and an inner wall of the hot-water tank are welded to each other at a plurality of locations, and a predetermined gap is provided between the periphery of the partition plate and the inner wall of the hot-water tank. According to the invention, it is possible to prevent crevice corrosion from being generated between the partition plate and the inner wall of the hot-water tank.

According to a sixth aspect of the invention, the heat pump type hot-water heater of the first aspect further comprises an upper heater located in the upper space, a lower heater located in the lower space, and a remote controller capable of separately setting a heating temperature of the upper heater and a heating temperature of the lower heater. According to the invention, since it is possible to separately set the heating temperature of hot water in the upper space and the heating temperature of hot water in the lower space, it is possible to reliably send hot water of desired temperature to the hot-water supply heat exchanger and the heating terminal.

An embodiment of the present invention will be described with reference to the drawings below. It should be noted that the invention is not limited to the embodiment.

### FIRST EMBODIMENT

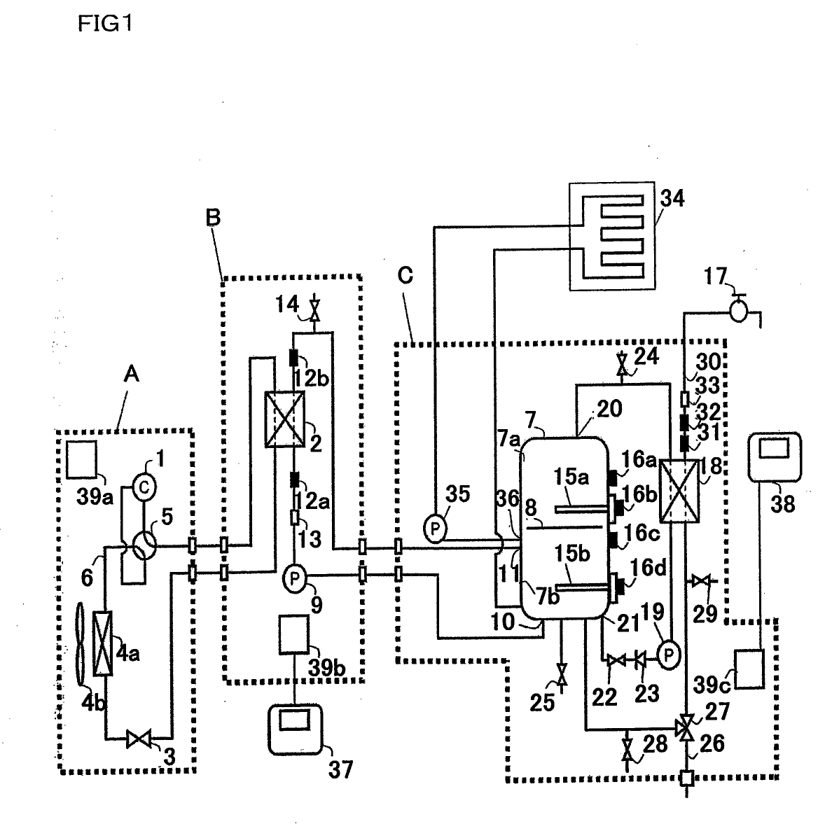

FIG. 1 is a block diagram of a heat pump type hot-water heater according to a first embodiment of the present invention. First, a structure of the heat pump type hot-water heater of the embodiment will be described using FIG. 1. The heat pump type hot-water heater of the embodiment includes three units, i.e., a heat pump unit A, a heat exchange unit B and a tank unit C. The heat pump unit A is disposed outdoors, and the heat exchange unit B and the tank unit C are disposed indoors.

The heat pump type hot-water heater of the embodiment includes a compressor 1 which compresses a refrigerant and discharges a high temperature refrigerant, a water refrigerant heat exchanger 2 which exchanges heat between water and the high temperature refrigerant to produce hot water, a decompressor 3 which decompresses a refrigerant, an evaporator 4a which exchanges heat between air and the refrigerant, and a four-way valve 5 which changes between channels of the refrigerant. The compressor 1, the water refrigerant heat exchanger 2, the decompressor 3, the evaporator 4a and the four-way valve 5 are annularly connected to one another through a refrigerant piping 6, thereby constituting a heat pump cycle. The heat pump type hot-water heater further includes an air-blowing fan 4b which blows air into the evaporator 4a to promote the heat exchange between air and a refrigerant. A plate type heat exchanger or a double-tube type heat exchanger can be used as the water refrigerant heat exchanger 2.

The water refrigerant heat exchanger 2 is disposed in the heat exchange unit B, and the compressor 1, the decompressor 3, the evaporator 4a and the four-way valve 5 are disposed in the heat pump unit A. An indoor side and an outdoor side are connected to each other through the refrigerant piping 6, and water piping which circulates through the water refrigerant heat exchanger 2 and a hot-water tank 7 is disposed indoors. Therefore, even if the heat pump type hot-water heater is disposed in a cold weather region, the water piping is less prone to be frozen. Although R410A is described as an example of a refrigerant in this embodiment, the present invention is not limited to this, and a CFC-based refrigerant such as R407C can also be used.

The hot-water tank 7 in which hot water is stored is included in the tank unit C. A partition plate 8 is disposed in the hot-water tank 7 at a substantially half height of the tank 7. A space in the hot-water tank 7 located higher than the partition plate 8 is a supplying hot water section 7a, and a space in the hot-water tank 7 located lower than the partition plate 8 is a heating hot water section 7b. If the interior of the hot-water tank 7 is divided into the upper space and the lower space in this manner, hot water in the supplying hot water section 7a can be used for heat exchange when hot water is supplied, and hot water in the heating hot water section 7b can be used for being circulated through the heating terminal at the time of the heating operation.

A water outlet 10 is provided in a lower portion of the hot-water tank 7. Water piping through which low temperature hot water is sent from the water outlet 10 to the water refrigerant heat exchanger 2 includes a boiling pump 9. By driving the boiling pump 9, low temperature hot water is sent from the water outlet 10 to the water refrigerant heat exchanger 2, heat is absorbed from a refrigerant by the water refrigerant heat exchanger 2, and hot water is produced.

Hot water produced by the water refrigerant heat exchanger 2 is returned to a hot water inlet 11 provided in an upper portion of the heating hot water section 7b. In this embodiment, the hot-water tank 7, the water outlet 10, the boiling pump 9, the water refrigerant heat exchanger 2 and the hot water inlet 11 are connected to one another through water piping, thereby constituting a boiling cycle. An AC pump having a constant circulation flow rate is used as the boiling pump 9.

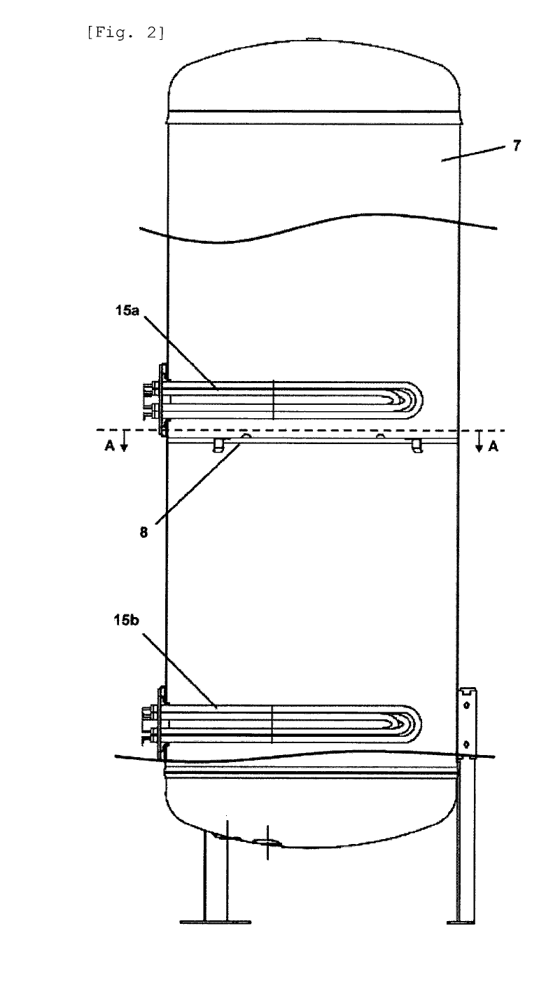

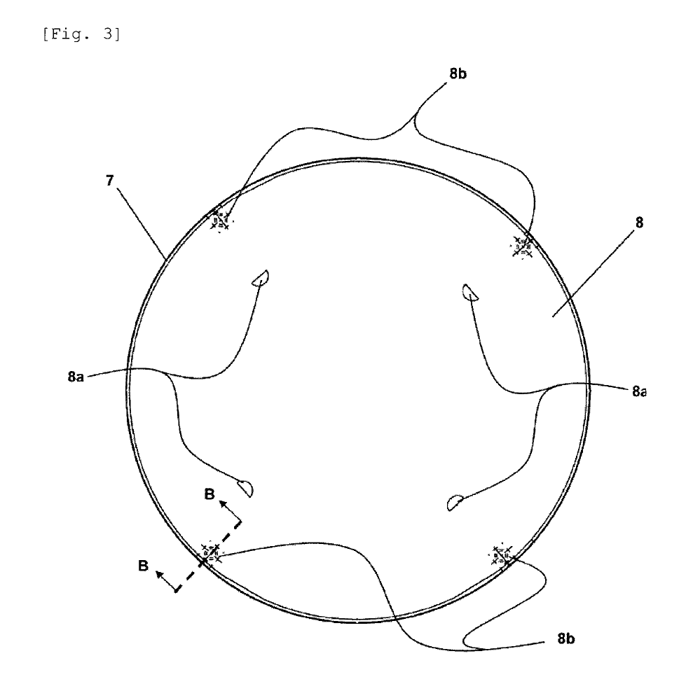

FIG. 2 is a partial sectional view of the hot-water tank 7. FIG. 3 is a sectional view taken along the A-A line in FIG. 2. As shown in FIGS. 2 and 3, the partition plate 8 is disposed at a substantially intermediate portion in the hot-water tank 7. As shown in FIG. 3, the partition plate 8 is provided with a plurality of openings 8a. When hot water which is heated by the heat pump cycle returns to the heating hot water section 7b, the hot water flows into the supplying hot water section 7a through the openings 8a. Although four openings 8a are provided in this embodiment, the present invention is not limited to the embodiment.

A periphery of the partition plate 8 and an inner wall of the hot-water tank 7 are welded to each other through four welding points 8b. Gaps are created between the periphery of the partition plate 8 and the hot-water tank 7 except at locations of the welding points. Hot water which returns from the hot water inlet 11 flows into the supplying hot water section 7a through the gaps created between the periphery of the partition plate 8 and the inner wall of the hot-water tank 7. Although four welding points 8b are provided in this embodiment, the invention is not limited to the embodiment.

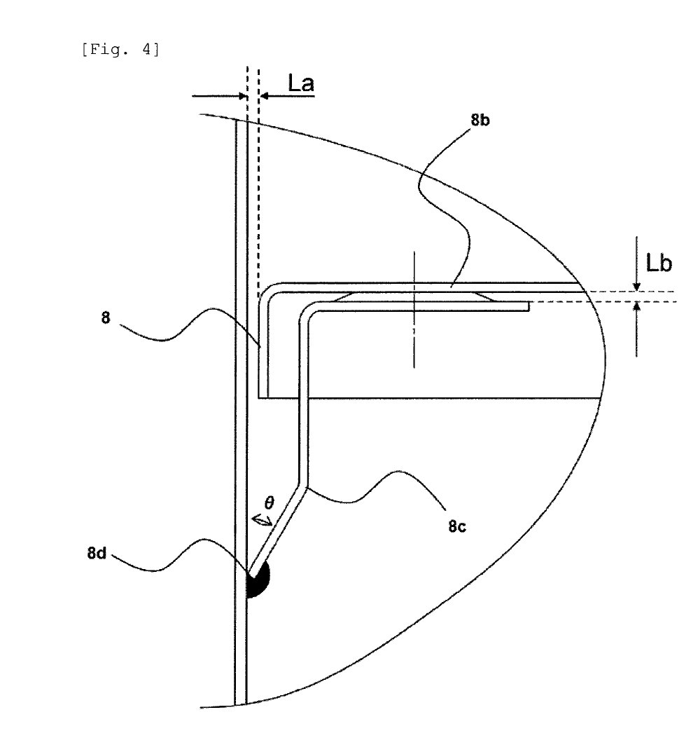

FIG. 4 is a sectional view taken along the B-B line in FIG. 3. As shown in FIG. 4, the partition plate 8 is welded to the hot-water tank 7 through an arm 8c. The arm 8c has an angle θ such as to separate from the inner wall of the hot-water tank 7, and the arm 8c is welded to the hot-water tank 7 at the welding point 8d. The partition plate 8 and the arm 8c are welded to each other at the welding point 8b.

The hot-water tank 7 and the partition plate 8 are made of stainless steel in terms of corrosion resistance. However, if a gap between the stainless steel materials is narrow, crevice corrosion is generated and as a result, there is a possibility that water leakage is generated. Therefore, in this embodiment, a predetermined gap La is provided between the partition plate 8 and the inner wall of the hot-water tank 7, and a predetermined gap Lb is provided between the partition plate 8 and the arm 8c. In this embodiment, the gaps are 50 μm or greater. Since the crevice corrosion is generated when the gap between the stainless steel materials is less than 40 μm, the predetermined gaps La and Lb are equal to or greater than 40 μm, thereby reliably preventing the crevice corrosion.

A temperature sensor 12a which detects the temperature of incoming water is provided in a water-side inlet of the water refrigerant heat exchanger 2. A temperature sensor 12b which detects the temperature of outgoing hot water is provided in a water-side outlet of the water refrigerant heat exchanger 2. A flow switch 13 which detects that hot water flows is provided in the boiling cycle.

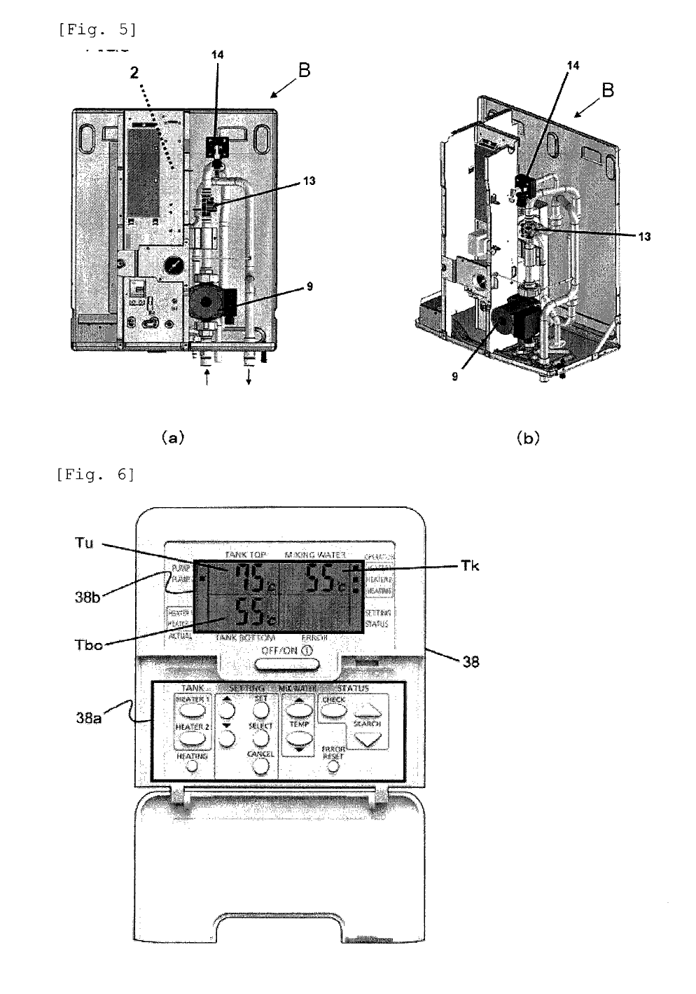

FIG. 5(a) is a front view of a structure of the heat exchange unit B, and FIG. 5 (b) is a perspective view of the partial structure of the heat exchange unit B. As shown in FIGS. 5(a) and (b), the boiling pump 9, the flow switch 13 and an overpressure relief valve 14 are provided in a side space of the water refrigerant heat exchanger 2 in the heat exchange unit B. The flow switch 13 detects a flow of hot water. The flow switch 13 is disposed at a location lower than the boiling pump 9. By disposing the flow switch 13 at the location lower than the boiling pump 9 in this manner, it is possible to detect that the boiling pump 9 is not normally operated.

The overpressure relief valve 14 which adjusts a pressure in the boiling cycle is provided at a location higher than the boiling pump 9. If an abnormal condition is generated in the boiling cycle and an internal pressure rises and the pressure rises higher than a set pressure of the overpressure relief valve 14, expanded hot water can be discharged out from the overpressure relief valve 14.

An upper heater 15a is disposed in the supplying hot water section 7a, and a lower heater 15b is disposed in the heating hot water section 7b. The upper heater 15a is used for heating hot water in the supplying hot water section 7a, and the lower heater 15b is used for heating hot water in the heating hot water section 7b.

Temperature sensors 16a to 16d are disposed on a sidewall of the hot-water tank 7 for detecting the temperature of hot water in the hot-water tank 7. The temperature sensor 16a is disposed at a location higher than the upper heater 15a, and the temperature sensor 16b is disposed at a location of substantially the same height as the upper heater 15a. The temperature sensor 16c is disposed at a location lower than the partition plate 8 and higher than the lower heater 15b. The temperature sensor 16d is disposed at a location of substantially the same height as the lower heater 15b.

A hot-water supply heat exchanger 18 which produces hot water to be sent to the hot-water supply terminal 17 is provided in the tank unit C. High temperature water in the hot-water tank 7 is sent to a primary channel of the hot-water supply heat exchanger 18, and low temperature hot water is sent from a water-supply source to a secondary channel of the hot-water supply heat exchanger 18.

Water piping for sending high temperature water in the hot-water tank 7 to the hot-water supply heat exchanger 18 is provided with a hot water supply pump 19. In the hot-water tank 7, the supplying hot water section 7a is provided at its upper portion with a hot water outlet 20, and is provided at its lower portion with a water inlet 21. By driving the hot water supply pump 19, high temperature water is sent from the hot water outlet 20 to the primary channel of the hot-water supply heat exchanger 18.

Hot water after its heat is exchanged by the hot-water supply heat exchanger 18 is returned to the hot-water tank 7 from the water inlet 21. In this embodiment, the hot-water tank 7, the hot water outlet 20, the hot-water supply heat exchanger 18, the hot water supply pump 19, and the water inlet 21 are connected to one another through the water piping to constitute a hot water supplying cycle. An AC pump having a constant circulation flow rate is used as the hot water supply pump 19.

The water piping between the hot water supply pump 19 and the water inlet 21 is provided with a check valve 23 and a flow rate adjusting valve 22 which adjusts a circulation flow rate of hot water in the boiling cycle. The check valve 23 is provided for preventing the convection of hot water in the hot water supplying cycle. When the hot water supply pump 19 is not driven, the check valve 23 prevents high temperature water in the upper portion of the hot-water tank 7 from entering into the lower portion of the hot-water tank 7 through the hot-water supply heat exchanger 18. This is because that if high temperature water flows into the lower portion of the hot-water tank 7, the temperature of hot water to be sent to the water refrigerant heat exchanger 2 rises, and the heating efficiency is deteriorated.

Hence, in this embodiment, the check valve 23 is provided so that hot water is circulated in the hot water supplying cycle in a normal direction only when the flow rate exceeds a predetermined load value. In this embodiment, hot water flows in the normal direction only when a load of 20 g is applied to the check valve 23 in the normal direction. The load value is not limited to 20 g.

An overpressure relief valve 24 which adjusts a pressure in the hot water supplying cycle is provided in the water piping from the hot water outlet 20 to the hot-water supply heat exchanger 18. When a pressure in the hot water supplying cycle becomes higher than a set pressure of the overpressure relief valve 24, hot water is discharged from the overpressure relief valve 24. The hot-water tank 7 is provided at its lower portion with a drain plug 25, and hot water in the hot-water tank 7 can be discharged outside.

The water piping extending form a water supply source is connected to a feed water pipe 26, the feed water pipe 26 is connected to a bottom of the hot-water tank 7 and to the secondary channel of the hot-water supply heat exchanger 18 through a three-way valve 27. The water piping between the three-way valve 27 and the hot-water tank 7 is provided with an overpressure relief valve 28, and expanded water can be discharged through the valve.

When the tank unit C is disposed, the three-way valve 27 is switched to one of the channels that is connected to the hot-water tank 7, water is stored in the hot-water tank 7, and after the hot-water tank 7 is fully filled with water, the three-way valve 27 is switched to one of channels that is connected to the hot-water supply heat exchanger 18. After water is supplied to the hot-water tank 7, the three-way valve 27 is switched to the channel connected to the hot-water supply heat exchanger 18. With this, since a water circuit including the hot-water tank 7 is closed, fresh water does not enter, and even in a region of hard water including much mineral, precipitation of scale can be suppressed only to a water amount that is initially supplied to the hot-water tank 7.

The water piping between the three-way valve 27 and the hot-water supply heat exchanger 18 is provided with an overpressure relief valve 29. A water supply pressure is directly applied from a water supply source to the hot-water supply heat exchanger 18. Therefore, if water is directly supplied to the hot-water supply heat exchanger 18 from the water supply source when the water supply pressure is high, there is a possibility that the hot-water supply heat exchanger 18 is destroyed and breaks down. Hence, the overpressure relief valve 29 is provided, and when hot water greater than a certain water supply pressure is supplied, the hot water is discharged outside through the overpressure relief valve 29, and it is possible to prevent the hot-water supply heat exchanger 18 from breaking down.

If low temperature hot water supplied from the water supply source is heated by the hot-water supply heat exchanger 18, the hot water is supplied to the hot-water supply terminal 17 through a hot water supply pipe 30. The hot water supply pipe 30 includes a temperature sensor 31 which is a hot water supply temperature detecting means, an auxiliary temperature sensor 32, and a flow rate sensor 33 which is a flow rate detecting means for detecting a flow rate.

The heat pump type hot-water heater includes a heating terminal 34 which heats a room. Hot water in the hot-water tank 7 is circulated through the heating terminal 34 to heat the room. For this purpose, the heat pump type hot-water heater includes a heating pump 35 for sending hot water from the heating hot water section 7b of the hot-water tank 7 to the heating terminal 34. Hot water which is to be sent to the heating terminal 34 is taken out from a hot water take-out port 36 provided near the hot water inlet 11, and hot water in the heating hot water section 7b is supplied to the heating terminal 34. Hot water after its heat is exchanged by the heating terminal 34 is returned to the bottom of the hot-water tank 7. An AC pump having a constant circulation flow rate is used as the heating pump 35.

The heat exchange unit B and the tank unit C are provided with remote controllers 37 and 38 for setting. The heat pump unit A, the heat exchange unit B and the tank unit C are provided with controllers 39a to 39c for giving instructions to driving devices disposed in the respective units.

In the heat pump type hot-water heater having the above-described structure, the operation of the heat pump type hot-water heater will be described below.

First, a heating operation will be described. First, a user sets a heating temperature Th of hot water in the water refrigerant heat exchanger 2 by the remote controller 37 provided in the heat exchange unit B. If the heating operation is started, hot water in the hot-water tank 7 driven by the boiling pump 9 is supplied to the water refrigerant heat exchanger 2. The heating operation until the heat pump cycle is continued until the temperature detected by the temperature sensor 12b exceeds the heating temperature Th. When heating the hot water in the hot-water tank 7 in the heat pump cycle, the four-way valve 5 is switched to select a channel through which a high temperature refrigerant discharged from the compressor 1 flows into the water refrigerant heat exchanger 2.

As a result, the high temperature refrigerant discharged from the compressor 1 flows into the water refrigerant heat exchanger 2, the refrigerant radiates heat to the hot water, thereby producing high temperature water. In the water refrigerant heat exchanger 2, water and a refrigerant are made to flow in the opposite directions to enhance the heat exchanging efficiency.

If the temperature of hot water coming from the water refrigerant heat exchanger 2 detected by the temperature sensor 12b approaches the heating temperature Th, the number of revolutions of the compressor 1 is reduced to lower the ability. If the temperature detected by the temperature sensor 12b becomes higher than the heating temperature Th by a predetermined temperature Ta (e.g., 2° C.), the operation of the compressor 1 is stopped and the heating operation is finished. The hot-water tank 7 is filled with hot water of the heating temperature Th.

High temperature water produced by the water refrigerant heat exchanger 2 is returned to the heating hot water section 7b, but the supplying hot water section 7a is filled with hot water of heating temperature Th through the gap formed between the periphery of the partition plate 8 and the hot-water tank 7. At that time, incoming water temperature Ti detected by the temperature sensor 12a is stored when the operation of the compressor 1 is stopped.

Also after the heating operation by the heat pump cycle is finished, the boiling pump 9 is driven and hot water in the hot-water tank 7 is circulated to the water refrigerant heat exchanger 2. This is because that it is necessary to detect the temperature of hot water in the hot-water tank 7 by the temperature sensor 12a and the temperature sensor 12b even while the heating operation is stopped, and the heating operation by the heat pump cycle must be restarted immediately after the temperature of hot water in the hot-water tank 7 goes down.

The boiling pump 9 is driven even while the hot water supplying operation is stopped, the hot water in the hot-water tank 7 is always detected by the temperature sensor 12a, the operation of the compressor 1 is restarted when the temperature detected by the temperature sensor 12b becomes lower, by a predetermined temperature Tb (e.g., 5° C.), than the incoming water temperature Ti which was stored when the operation of the compressor 1 was stopped, and the heating operation is started.

If the heating temperature Th is set at 55° C. for example, the operation of the compressor 1 is stopped when the temperature detected by the temperature sensor 12b exceeds 57° C. (=55° C.+2° C.). If the temperature when the operation of the compressor 1 is stopped is 53° C., the fact that the incoming water temperature Ti is 53° C. is stored. Even after the operation of the compressor 1 is stopped, the boiling pump 9 is driven, and when the temperature detected by the temperature sensor 12b becomes lower than the incoming water temperature Ti by a predetermined temperature Tb (e.g., 5° C.), the operation of the compressor 1 is restarted. The predetermined temperatures Ta and Tb shown in this embodiment are only one example, and the invention is not limited to the embodiment.

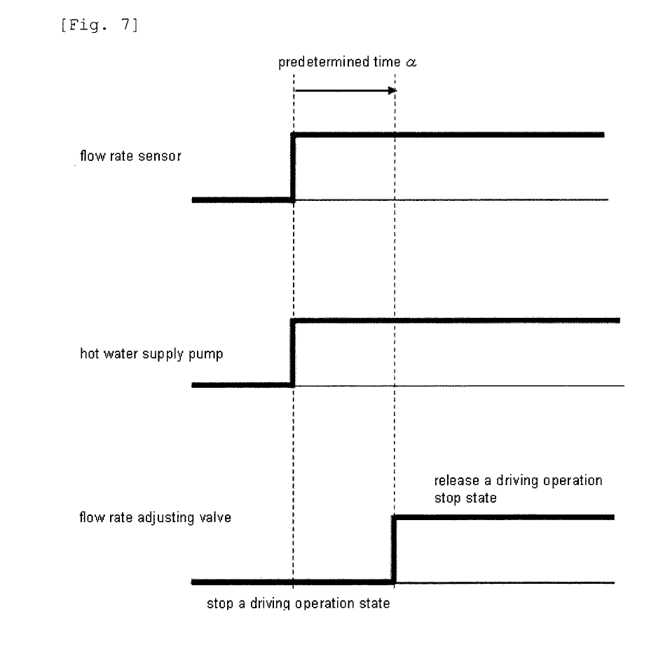

The heating temperature handled by the upper heater 15a can be set by the remote controller 38 provided in the tank unit C. FIG. 6 is a front view of the remote controller 38. As shown in FIG. 6, the remote controller 38 includes an operating section 38a and a display section 38b, and a temperature can be set by operating the operating section 38a. In this embodiment, a heating temperature Tu of the upper heater 15a, a heating temperature Tbo of the lower heater 15b, and a hot water supplying temperature Tk supplied to the hot-water supply terminal 17 can be set by operating the operating section 38a.

In this embodiment, the heating temperature Tu of the upper heater 15a is set at a temperature higher than the heating temperature Th that is set by the remote controller 37. With this, it is possible to heat the hot water in the supplying hot water section 7a to the heating temperature Tu. For example, if the heating temperature Th is set at 55° C. by the remote controller 37 and the heating temperature Tu is set at 75° C. by the remote controller 38, the hot water is heated to the heating temperature Th (55° C.) by the water refrigerant heat exchanger 2 and the heating operation is carried out until the temperature becomes equal to 75° C. by the upper heater 15a.

Since the temperatures in the upper and lower spaces of the partition plate 8 can be set at different heating temperatures in this manner, it is possible to heat the water to optimal temperature in accordance with respective terminals, and usability can be enhanced.

Next, the heating operation by the upper heater 15a will be described. When the operation of the upper heater 15a is started, the output of the upper heater 15a is turned ON in the case of detecting that a temperature detected by the temperature sensor 16a provided at a location higher than the upper heater 15a is lower than the heating temperature Tu by a predetermined temperature Tank unit C (e.g., 5° C.). The hot water in the supplying hot water section 7a is heated by the upper heater 15a, and when a temperature detected by the temperature sensor 16b provided at a position that is the same as that of the upper heater 15a becomes higher than the heating temperature Tu by a predetermined temperature Td (e.g., 2° C.), the output of the upper heater 15a is turned OFF.

The temperature sensor which determines when the upper heater 15a is turned ON and the temperature sensor which determines when the upper heater 15a is turned OFF are different from each other. With this, ON and OFF of the upper heater 15a are not frequently switched, and durability of the upper heater 15a is enhanced. The predetermined temperatures Tc and Td shown in this embodiment are only one example, and the invention is not limited to the embodiment.

Next, the heating operation by the lower heater 15b will be described. The lower heater 15b is turned ON when the heating operation of the heat pump unit A can not be carried out. With this, it is possible to prevent a temperature of hot water in the heating hot water section 7b from going down.

If the heating operation is continued, frost is formed on the evaporator 4a, and a defrosting operation must be carried out. In such a case, a high temperature refrigerant coming out from the compressor 1 is made to flow into the evaporator 4a by switching the refrigerant channel by the four-way valve 5, and the defrosting operation is carried out at a temperature of the refrigerant.

However, since a heat of the refrigerant can not be radiated by the water refrigerant heat exchanger 2 during the defrosting operation, hot water can not be produced by the water refrigerant heat exchanger 2. As a result, the temperature of hot water in the heating hot water section 7b goes down, and the temperature of hot water to be supplied to the heating terminal 34 goes down. To avoid such a case, the lower heater 15b is turned ON to prevent the temperature of hot water in the heating hot water section 7b from going down, and the degree of comfort at the heating terminal 34 can be maintained. Not only when the defrosting operation is carried out, but also when the heat pump unit A breaks down, hot water in the heating hot water section 7b can be heated by the lower heater 15b.

In this embodiment, the heating temperature Tbo at the lower heater 15b can be set by the remote controller 38. The heating temperature Tbo is set at the same temperature as the heating temperature Th in many cases. In the heating hot water section 7b, there exists such a temperature distribution that a temperature of the upper portion is high and a temperature of the lower portion is low.

Therefore, even if the temperature of hot water that is returned from the water refrigerant heat exchanger 2 is equal to the heating temperature Th (=Tbo), a temperature detected by the temperature sensor 16d becomes lower than the heating temperature Th (=Tbo). This is because that hot water after its heat is radiated by the heating terminal 34 and hot water after its heat is radiated by the hot-water supply heat exchanger 18 are returned to the lower portion of the hot-water tank 7.

As a result, if the lower heater 15b is controlled such that the temperature detected by the temperature sensor 16d is maintained at the heating temperature Tbo, the lower heater 15b is turned ON if the temperature detected by the temperature sensor 16d becomes lower than the heating temperature Tbo even a little, and the heating operation is carried out by the lower heater 15b frequently.

It is efficient to carry out the heating operation of hot water in the heating hot water section 7b using the heat pump unit A without using the lower heater 15b. Hence, in this embodiment, the control is carried out such that the lower heater 15b is turned ON only when it is detected that the temperature detected by the temperature sensor 16d is lower than the heating temperature Tbo by a predetermined temperature Te (e.g., 10° C.).

As a result, when the heating temperature Tbo is set at the heating temperature Th, hot water is heated to the heating temperature Th by the heat pump unit A in the heating hot water section 7b, and the lower heater 15b is not turned ON unless it is detected that the temperature detected by the temperature sensor 16d is lower than the heating temperature Tbo by the predetermined temperature Te.

When the defrosting operation of the evaporator 4a is carried out or when the ability of the heat pump unit A is not obtained, the lower heater 15b can be turned ON only when it is detected that the temperature detected by the temperature sensor 16d is lower than the heating temperature Tbo by the predetermined temperature Te, and extremely efficient heating operation can be carried out.

When the heating operation is carried out by the lower heater 15b, if it is necessary to stop the lower heater 15b, the heating operation is carried out such that the lower heater 15b is turned OFF when it is detected that the temperature detected by the temperature sensor 16d is higher than the heating temperature Tbo by a predetermined temperature Tf (e.g., 2° C.).

Since both the heating operation by the heat pump unit A and heating operation by the lower heater 15b are used, the hot water in the heating hot water section 7b is maintained at the heating temperature Tbo even in a state where the heating operation by the heat pump unit A is not carried out due to the defrosting operation of the evaporator 4a, hot water can stably be sent to the heating terminal 34, and the degree of comfort is not deteriorated. The predetermined temperatures Te and Tf shown in this embodiment are only one example, and the invention is not limited to the embodiment.

Next, the heating operation will be described. If a user operates the remote controller 38 and starts the heating operation, the heating pump 35 is driven, and hot water in the heating hot water section 7b is supplied to the heating terminal 34. The hot water whose heat is radiated by the heating terminal 34 is returned to the lower portion of the hot-water tank 7. Since the AC pump is used as the heating pump 35, hot water of a constant flow rate is circulated at the time of the heating operation.

Next, the hot water supplying operation will be described. A user first sets a hot water supplying set temperature Tk by the remote controller 38. Then, the user starts the supply of hot water from the hot-water supply terminal 17, and when the flow rate sensor 33 detects that a flow rate of hot water reaches a predetermined value, the hot water supply pump 19 is driven, and high temperature water in the supplying hot water section 7a is sent to the hot-water supply heat exchanger 18.

An opening of the flow rate adjusting valve 22 is adjusted in accordance with a temperature deviation between a temperature T1 detected by the temperature sensor 31 and the hot water supplying set temperature Tk, and feedback control is performed such that the temperature T1 detected by the temperature sensor 31 becomes equal to the hot water supplying set temperature Tk. The hot water after its heat is radiated by the hot-water supply heat exchanger 18 is returned to the lower portion of the heating hot water section 7b.

A higher portion in the heating hot water section 7b has a higher temperature layer. Therefore, even if hot water after its heat is radiated by the hot-water supply heat exchanger 18 is returned to the lower portion of the heating hot water section 7b, influence exerted on the temperature of hot water that is to be sent to the heating terminal 34 is small.

The high temperature water in the supplying hot water section 7a is used as hot water to be sent to the hot-water supply heat exchanger 18, and high temperature water in the heating hot water section 7b is used as hot water to be sent to the heating terminal 34. Therefore, it is possible to suppress the influence exerted on the hot water supplying operation received by hot water that is to be sent to the heating terminal 34.

When a flow of hot water is not detected by the flow rate sensor 33, if it is detected that the hot water temperature T1 detected by the temperature sensor 31 is equal to or higher than a hot water supply abnormal temperature Tj (e.g., 65° C.), it is determined that an abnormal condition occurs, the driving operation of the hot water supply pump 19 is stopped, the opening of the flow rate adjusting valve 22 is fully closed so as to reliably prevent the high temperature hot water in the hot-water tank 7 from being sent to the hot-water supply heat exchanger 18. This can prevent high temperature hot water in the hot-water tank 7 from being used wastefully and prevent hot water in the hot-water tank 7 from running out. The predetermined temperature Tj shown in this embodiment is only one example, and the invention is not limited to the embodiment.

The heat pump type hot-water heater of the embodiment includes the auxiliary temperature sensor 32. This prevents high temperature water from being sent from the hot-water supply terminal 17. Next, detection of abnormal condition by the auxiliary temperature sensor 32 at the time of the hot water supplying operation will be described.

When the hot water supplying operation is being carried out, a temperature of hot water to be supplied to the hot-water supply terminal 17 is detected by the auxiliary temperature sensor 32, and a temperature deviation between the hot water temperature T1 detected by the temperature sensor 31 and a hot water temperature T2 detected by the auxiliary temperature sensor 32 is detected.

If it is detected that the hot water temperature T2 is higher than the high temperature by a predetermined temperature Tg (e.g., 8° C.), there is a possibility that the temperature sensor 31 is improperly operated and that high temperature water is sent to the hot-water supply terminal 17. Therefore, the driving operation of the hot water supply pump 19 is stopped, and the opening of the flow rate adjusting valve 22 is fully closed. As a result, high temperature water is not sent from the hot-water supply terminal 17, and safety can be secured. The predetermined temperature Tg shown in this embodiment is only one example, and the invention is not limited to the embodiment.

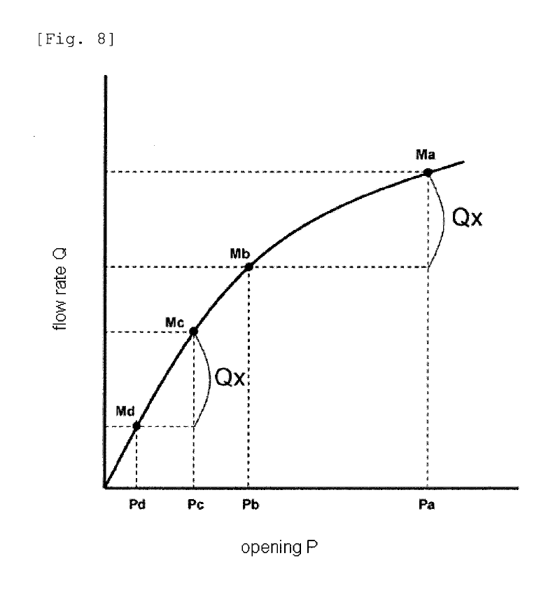

Next, control of the flow rate adjusting valve 22 at the time of the hot water supplying operation will be described. FIG. 7 is a driving timing diagram of the hot water supply pump 19 and the flow-rate adjusting valve 22 of the first embodiment. If a user flows hot water from the hot-water supply terminal 17, and the flow rate sensor 33 detects that a flow rate reaches a predetermined value, the driving operation of the hot water supply pump 19 is started.

The driving operation of the flow rate adjusting valve 22 is started if a predetermined time α(e.g., 8 seconds) is elapsed after the driving operation of the hot water supply pump 19 is started, and the opening of the flow rate adjusting valve 22 is adjusted such that the temperature T1 detected by the temperature sensor 31 becomes equal to the hot water supplying set temperature Tk. The opening of the flow rate adjusting valve 22 is maintained at a predetermined value during the predetermined time α.

It is possible to prevent the hunting of a temperature of hot water to be supplied to the hot-water supply terminal 17 by delaying the starting timing of the driving operation of the flow rate adjusting valve 22 from the start of the driving operation of the hot water supply pump 19 by the predetermined time α.

If the hot water supplying operation is not carried out for a long time after the last hot water supplying operation is finished, the hot-water supply heat exchanger 18 is cooled. Therefore, the flow rate of hot water to be sent from the hot-water tank 7 to the hot-water supply heat exchanger 18 is made constant until the temperature of the hot-water supply heat exchanger 18 is stabilized after the hot water supplying operation is started. With this, the hunting of the temperature of hot water to be supplied to the hot-water supply terminal 17 is prevented.

The opening of the flow rate adjusting valve 22 during the hot water supplying operation will be described next. The control of the flow rate adjusting valve 22 during the normal hot water supplying operation is performed based on the temperature T1 detected by the temperature sensor 31. Since the hot water supplying set temperature Tk is set by the remote controller 38, the opening of the flow rate adjusting valve 22 is adjusted such that the temperature detected by the temperature sensor 31 becomes equal to the hot water supplying set temperature Tk.

However, if the flow rate of hot water sent from the water supply source to the hot-water supply heat exchanger 18 is varied by operating the hot-water supply terminal 17, a balance between high temperature hot water sent from the hot-water tank 7 to the hot-water supply heat exchanger 18 and low temperature hot water sent from the water supply source to the hot-water supply heat exchanger 18 is lost, and hunting occurs in the temperature of hot water to be supplied to the hot-water supply terminal 17.

Hence, in this embodiment, the opening of the flow rate adjusting valve 22 is determined in accordance with the flow rate variation of hot water detected by the flow rate sensor 33.

If a user starts the hot water releasing operation of hot water from the hot-water supply terminal 17, the opening of the flow rate adjusting valve 22 is adjusted such that the temperature T1 detected by the temperature sensor 31 becomes equal to the hot water supplying set temperature Tk. If the user operates the hot-water supply terminal 17 and a flow rate detected by the flow rate sensor 33 is varied, a thermal balance in the hot-water supply heat exchanger 18 is lost.

For this reason, several seconds are elapsed until a temperature detected by the temperature sensor 31 is varied after the flow rate of hot water to be supplied to the hot-water supply terminal 17 is varied. Therefore, if the opening of the flow rate adjusting valve 22 is controlled based on the temperature detected by the temperature sensor 31, the temperature of hot water to be supplied to the hot-water supply terminal 17 is vertically hunted.

In this embodiment, a flow rate Qa before a predetermined time La is always stored, and a current flow rate Qo and the flow rate Qa before the predetermined time La are compared with each other. As a result of the comparison of the flow rates, if there is an increase more than a flow rate Qd, the opening of the flow rate adjusting valve 22 is driven to a target opening Pt irrespective of the temperature T1 detected by the temperature sensor 31.

The target opening Pt is determined in accordance with the current flow rate Qo, the flow rate Qa before the predetermined time La and the current opening Pn of the flow rate adjusting valve 22. If the current flow rate Qo is increased more than the flow rate Qa before the predetermined time La, this means that the amount of hot water to be supplied to the hot-water supply terminal 17 is increased. Therefore, it is necessary to supply much more high temperature hot water from the hot-water tank 7 to the hot-water supply exchanger 18, the target opening Pt is made greater than the current opening Pn.

Next, the current flow rate Qo and the flow rate Qa before the predetermined time La are compared with each other, and if there is a reduction more than the flow rate Qd, the opening of the flow rate adjusting valve 22 is driven to the target opening Pt irrespective of the temperature T1 detected by the temperature sensor 31.

The target opening Pt is determined in accordance with the current flow rate Qo, the flow rate Qa before the predetermined time La and the current opening Pn of the flow rate adjusting valve 22. At that time, if the current flow rate Qo is reduced more than the flow rate Qa before the predetermined time La, this means that the amount of hot water to be supplied to the hot-water supply terminal 17 is reduced. Therefore, since it is necessary to reduce the high temperature hot water to be supplied from the hot-water tank 7 to the hot-water supply heat exchanger 18, the target opening Pt is made smaller than the current opening Pn.

As described above, when a flow rate of hot water to be supplied to the hot-water supply terminal 17 is largely varied, the opening of the flow rate adjusting valve 22 is driven to the target opening Pt irrespective of a temperature detected by the temperature sensor 31. With this, it is possible to suppress the hunting of hot water to be supplied to the hot-water supply terminal 17.

Further, even if the opening of the flow rate adjusting valve 22 is varied from the current opening Pn to the target opening Pt, a temperature T1 detected by the temperature sensor 31 largely overshoots in some cases. Hence, in this embodiment, when the temperature T1 detected by the temperature sensor 31 is higher than the hot water supplying set temperature Tk by a predetermined temperature Ty (e.g., 3° C.), the opening of the flow rate adjusting valve 22 is reduced by a predetermined opening degree D.

Further, a predetermined opening degree D is different between a case where a current flow rate Qo detected by the flow rate sensor 33 is large and a case where the current flow rate Qo detected by the flow rate sensor 33 is small. That is, it is determined whether the current flow rate Qo is greater than the predetermined flow rate Qb (e.g., 5 L/min), and if the current flow rate Qo is greater than the predetermined flow rate Qb, the opening of the flow rate adjusting valve 22 is further reduced by a predetermined opening degree Da, and when the current flow rate Qo is smaller than the predetermined flow rate Qb, the opening of the flow rate adjusting valve 22 is further reduced by a predetermined opening degree Db. At that time, a relation “predetermined opening degree Da>predetermined opening degree Db” is established.

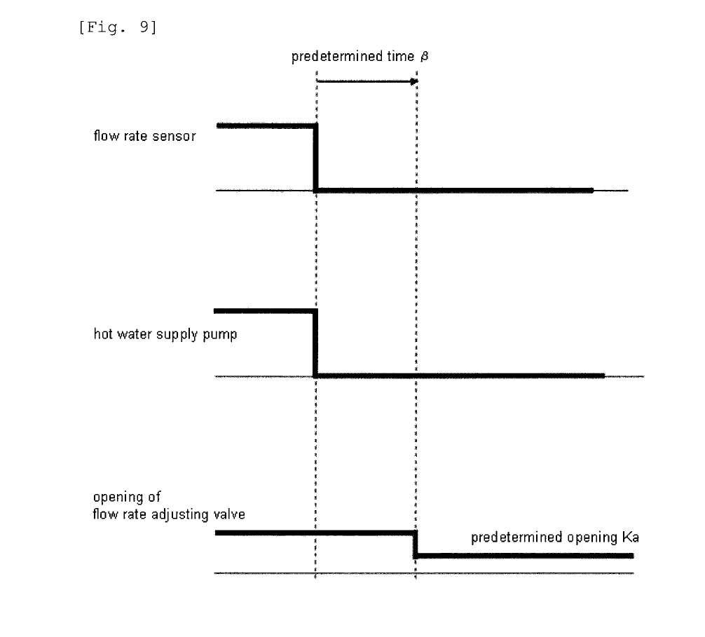

FIG. 8 is a characteristic diagram of the flow-rate adjusting valve 22. In FIG. 8, the horizontal axis shows the opening P of the flow rate adjusting valve 22 and the vertical axis shows a flow rate Q. As shown in FIG. 8, it can be found that a variation amount of a flow rate when the opening of the flow rate adjusting valve 22 is small and a variation amount of a flow rate when the opening of the flow rate adjusting valve 22 is large are different from each other. For example, in order to reduce the opening Pa that corresponds to the large flow rate from a point Ma by a flow rate Qx, it is necessary to reduce the flow rate to a point Mb that corresponds to the opening Pb, but in order to reduce the opening Pc that corresponds to a small flow rate from a point Mc by a flow rate Qx, it is only necessary to reduce the flow rate to a point Md that corresponds to the opening Pd. That is, it can be found that as a flow rate is greater, it is necessary to largely reduce the opening to reduce a flow rate. In this embodiment, the predetermined opening degree Da is set greater than the predetermined opening degree Db, and as the current flow rate Qo is greater, the opening is reduced greater.

As shown in FIG. 8, the flow rate adjusting valve 22 has such characteristics that as the opening thereof is smaller, a variation in flow rate is greater. Control is performed such that a driving speed when the opening of the flow rate adjusting valve 22 is reduced by the predetermined opening degree Da becomes faster than a driving speed when the opening of the flow rate adjusting valve 22 is reduced by the predetermined opening degree Db. As described above, the variation in the opening of the flow rate adjusting valve 22 is controlled in two kinds, i.e., the predetermined opening degree Da and the predetermined opening degree Db depending upon whether the current flow rate Qo is greater or smaller than the predetermined flow rate Qb, and the driving speed of the flow rate adjusting valve 22 is controlled independently depending upon whether the current flow rate Qo is large and small. With this, control suitable for characteristics of the flow rate adjusting valve 22 can be carried out, and the overshoot time can further be reduced. The predetermined temperature Ty, the predetermined flow rate Qb, and the predetermined opening degrees Da and Db shown in the embodiment are only one example, and the invention is not limited to the embodiment.

Next, the opening of the flow rate adjusting valve 22 when the hot water supplying operation is stopped will be described. The hot-water supply heat exchanger 18 keeps heat within a predetermined time β (e.g., 10 min) after the hot water supplying operation is finished. Therefore, the opening of the flow rate adjusting valve 22 when the hot water supplying operation is finished is maintained, and when hot water is again released from the hot-water supply terminal 17, hot water is supplied to the hot-water supply terminal 17 at the same temperature as that when the hot water supplying operation is carried out last time. However, after the predetermined time β is elapsed after the hot water supplying operation is finished, there is a possibility that the temperature of the hot-water supply heat exchanger 18 goes down or hot water in the hot-water tank 7 is heated. Therefore, when hot water is released from the hot-water supply terminal 17 next time, hunting occurs in a temperature of the hot water released from the hot-water supply heat exchanger 18, and there is a possibility that high temperature hot water is supplied to the hot-water supply terminal 17.

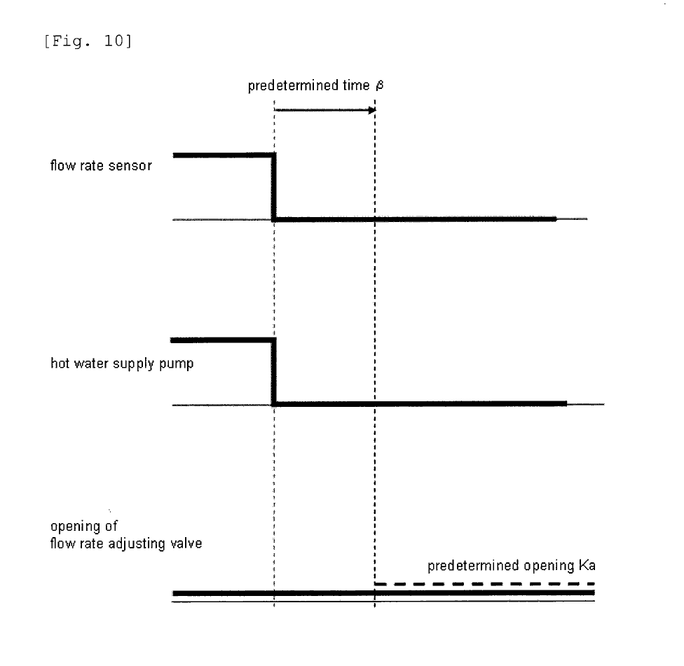

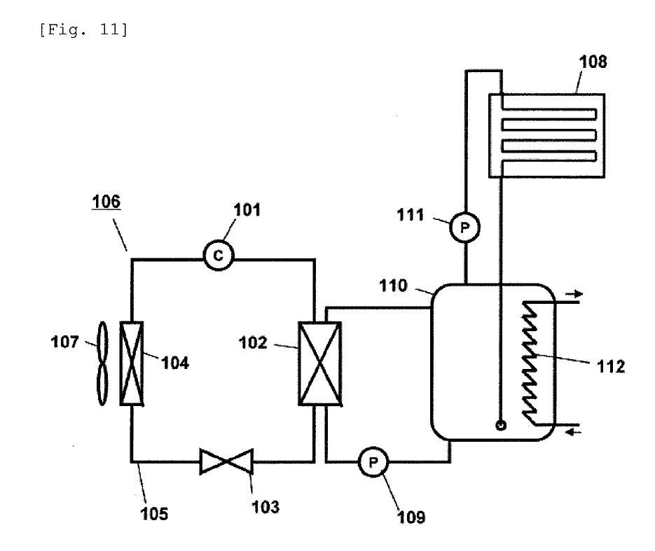

FIGS. 9 and 10 show the opening of the flow rate adjusting valve 22 after the hot water supplying operation is finished. The opening of the flow rate adjusting valve 22 will be described using FIGS. 9 and 10. As shown in FIG. 9, after the predetermined time β is elapsed from the end of the hot water supplying operation, it is determined whether the opening of the flow rate adjusting valve 22 when the hot water supplying operation is finished is greater than a predetermined opening degree Ka. If the opening of the flow rate adjusting valve 22 is greater than the predetermined opening degree Ka, there is a possibility that high temperature hot water is sent to the hot-water supply terminal when the hot water supplying operation is carried out next time. Therefore, the opening of the flow rate adjusting valve 22 is driven until it becomes equal to the predetermined opening degree Ka. When the opening of the flow rate adjusting valve 22 is driven to the predetermined opening degree Ka, the flow rate adjusting valve 22 is fully closed and the original position is checked and then, the opening is driven to the predetermined opening degree Ka. By checking the original position, it is possible to hold the flow rate adjusting valve 22 with a precise opening, and this prevents high temperature hot water from being supplied to the hot-water supply terminal 17 when the hot water supplying operation is carried out next time.

As shown in FIG. 10, if the opening of the flow rate adjusting valve 22 when the hot water supplying operation is finished is smaller than the predetermined opening degree Ka, there is no possibility that high temperature hot water is sent to the hot-water supply terminal when the hot water supplying operation is carried out next time. Therefore, the opening of the flow rate adjusting valve 22 when the hot water supplying operation is finished is maintained as it is in preparation for next time hot water supplying operation. By adjusting the opening of the flow rate adjusting valve 22 when the hot water supplying operation is not carried out as described above, it is possible to prevent high temperature hot water from being sent to the hot-water supply terminal 17 when the hot water supplying operation is carried out next time. The predetermined opening degree Ka has such a value that a temperature of hot water to be supplied does not exceed a predetermined temperature irrespective of a flow rate of hot water released from the hot-water supply terminal 17, and this value can appropriately be changed in accordance with respective systems. The predetermined time α and β shown in the embodiment is only one example, and the invention is not limited to the embodiment.

### INDUSTRIAL APPLICABILITY

As described above, according to the heat pump type hot-water heater of the present invention, even if hot water in one hot-water tank is used as both a heat source for hot water supplying operation and a heat source for heating a room, respective influences are minimized, and usability is extremely high. A floor heating panel, a radiation panel and the like can be used as the heating terminal.

1. A heat pump type hot-water heater comprising a hot-water tank in which hot water is stored, a heat pump cycle for heating hot water in the hot-water tank, a partition plate for dividing an interior of the hot-water tank into an upper space and a lower space, a hot-water supply heat exchanger which exchanges heat between water supplied from a water supply source and hot water in the hot-water tank to heat the water to a high temperature, a hot water supply pump which sends hot water in the hot-water tank to the hot-water supply heat exchanger, a heating terminal which circulates hot water in the hot-water tank and heats a room, and a heating pump which sends hot water in the hot-water tank to the heating terminal, wherein hot water in the upper space is sent to the hot-water supply heat exchanger, hot water after its heat is exchanged by the hot-water supply heat exchanger is returned from a bottom of the hot-water tank, hot water in the lower space is sent to the heating terminal, and hot water after its heat is exchanged by the heating terminal is returned from the bottom of the hot-water tank.

2. The heat pump type hot-water heater according to claim 1, further comprising an upper heater located in the upper space and a lower heater located in the lower space, wherein hot water heated by the heat pump cycle is returned to the lower space, and hot water in the upper space is heated to a temperature that is higher than a temperature of the hot water in the lower space.

3. The heat pump type-hot-water heater according to claim 2, further comprising a first temperature sensor in a location at substantially the same height as the upper heater, and a second temperature sensor in a location higher than the first temperature sensor, wherein a heating operation of the upper heater is started based on the second temperature sensor, and the heating operation of the upper heater is stopped based on the first temperature sensor.

4. The heat pump type hot-water heater according to claim 1, wherein the partition plate includes a plurality of openings.

5. The heat pump type hot-water heater according to claim 1, wherein a periphery of the partition plate and an inner wall of the hot-water tank are welded to each other at a plurality of locations, and a predetermined gap is provided between the periphery of the partition plate and the inner wall of the hot-water tank.

6. The heat pump type hot-water heater according to claim 1, further comprising an upper heater located in the upper space, a lower heater located in the lower space, and a remote controller capable of separately setting a heating temperature of the upper heater and a heating temperature of the lower heater.

7. The heat pump type hot-water heater according to claim 2, wherein the partition plate includes a plurality of openings.

8. The heat pump type hot-water heater according to claim 3, wherein the partition plate includes a plurality of openings.

9. The heat pump type hot-water heater according to claim 2, wherein a periphery of the partition plate and an inner wall of the hot-water tank are welded to each other at a plurality of locations, and a predetermined gap is provided between the periphery of the partition plate and the inner wall of the hot-water tank.

10. The heat pump type hot-water heater according to claim 3, wherein a periphery of the partition plate and an inner wall of the hot-water tank are welded to each other at a plurality of locations, and a predetermined gap is provided between the periphery of the partition plate and the inner wall of the hot-water tank.

11. The heat pump type hot-water heater according to claim 4, wherein a periphery of the partition plate and an inner wall of the hot-water tank are welded to each other at a plurality of locations, and a predetermined gap is provided between the periphery of the partition plate and the inner wall of the hot-water tank.

12. The heat pump type hot-water heater according to claim 7, wherein a periphery of the partition plate and an inner wall of the hot-water tank are welded to each other at a plurality of locations, and a predetermined gap is provided between the periphery of the partition plate and the inner wall of the hot-water tank.

13. The heat pump type hot-water heater according to claim 8, wherein a periphery of the partition plate and an inner wall of the hot-water tank are welded to each other at a plurality of locations, and a predetermined gap is provided between the periphery of the partition plate and the inner wall of the hot-water tank.
